(19) United States
(12) Patent Application Publication
(10) Pub. No.: US 2025/0258528 A1
(43) Pub. Date: Aug. 14, 2025

(54) SYSTEMS, METHODS, AND DEVICES FOR DATA CENTER POWER MANAGEMENT

(71) Applicant: SAI US, INC., Marietta, OH (US)

(72) Inventor: Tao Wu, Tempe, AZ (US)

(21) Appl. No.: 18/436,803

(22) Filed: Feb. 8, 2024

(51) Int. Cl. G06F 1/26

(52) U.S. Cl. CPC G06F 1/26

(57) ABSTRACT

Data centers and methods are disclosed. The data center may comprise crypto miner servers and a network switch between the crypto miner servers and a crypto network, for selectively interrupting communication between the crypto miner servers and the crypto network, thereby controlling the use of one or more of the plurality of servers for crypto mining activity and thereby controlling the associated power usage of the data center. The data center further comprises a network management system configured to receive communications from an electricity power usage management system and to control the network switch based on the communications to achieve a desired power usage for the data center. The data center May further comprise conventional computing servers and crypto mining servers and a power management system, wherein the power management system is configured to control the use of one or more the crypto mining servers to maintain a constant total data center power usage.

### FIELD OF INVENTION

The present disclosure relates generally to data center power management, and, in particular, to a data center power management in the context of crypto mining processing in a data center.

### BACKGROUND

A conventional computing data center is a specialized facility designed specifically for high-performance computing (HPC) and data-intensive tasks. These centers often contain clusters of powerful servers equipped with high-performance GPUs (Graphics Processing Units) or TPUs (Tensor Processing Units). Computing data centers are primarily focused on compute-intensive tasks including scientific research, weather modeling, financial simulations, deep learning, and other HPC workloads that demand massive computational power.

Data centers can also be used for the task of cryptocurrency mining. Cryptocurrency mining is the process by which cryptocurrencies (for example, Bitcoin and Ethereum) are created and transactions are verified and added to the blockchain. Crypto currency mining involves “miners” solving complex mathematical problems through computational power, and in return, miners are rewarded with new cryptocurrency coins and transaction fees. Each cryptocurrency miner is competing with all the other miners on the network to be the first one to correctly assemble the outstanding transactions into a block by solving a set of specialized math problems. In exchange for validating the transactions and solving these problems, cryptocurrency miners are rewarded for all of the transactions they process. They receive fees attached to all of the transactions that they successfully validate and include in a block. In addition to transaction fees, miners also receive an additional award for each block they mine. This block reward is also the process by which new cryptocurrencies are created.

Cryptocurrency mining, particularly in Proof of Work (PoW) systems like Bitcoin, can be associated with significant power consumption. Because data centers consume relatively large amounts of power, the cost of energy to run the data centers is significant. Improved systems and methods for reducing the cost of energy to run the data centers are needed.

### SUMMARY

In an example embodiment, a data center is disclosed comprising: electric equipment including a plurality of servers, comprising crypto miner servers. The data center further comprises a network switch between the crypto miner servers and a crypto network, for selectively interrupting communication between the crypto miner servers and the crypto network, and thereby controlling the use of one or more of the plurality of servers for crypto mining activity and thereby controlling the associated power usage of the data center. The data center further comprises a network management system configured to receive communications from an electricity power usage management system and to control the network switch based on the communications to achieve a desired power usage for the data center.

In another example embodiment, a method for controlling power usage in a data center is disclosed. The method may comprise: receiving, at a network management system, a command to change the power usage by a specified amount; determining, by the network management system, an amount of mining activity to change; and commanding a network switch to open or close in accordance with said determination, to cause the commanded change in power usage, wherein the network switch is located between the crypto miners and the crypto network.

In another example embodiment, a data center is disclosed comprising: conventional computing servers having a total conventional computing server power usage and crypto mining servers having a total crypto mining server power usage. In an example embodiment, a total data center power usage equals the total conventional computing server power usage plus the total cryptomining server power usage. In an example embodiment, the data center further comprises a power management system, wherein the power management system is configured to control the use of one or more the crypto mining servers to maintain a constant total data center power usage.

In another example embodiment, a method is disclosed comprising: measuring, via one or more power meters, a total power usage for a data center; comparing, via a processor at a power management system, the total power usage for the data center to a previously measured total power usage for the data center; and adjusting the cryptomining total power usage to maintain a relatively constant data center power usage.

### BRIEF DESCRIPTION OF THE DRAWING FIGURES

Additional aspects of the present disclosure will become evident upon reviewing the non-limiting embodiments described in the specification and the claims taken in conjunction with the accompanying figures, wherein like numerals designate like elements, and:

FIG. 1 illustrates a cryptomining data center, in accordance with various example embodiments;

FIG. 2 is a block diagram illustrating a data center comprised of conventional and cryptomining computing servers and a power management system, in accordance with various example embodiments;

FIG. 3 illustrates a typical system for directly controlling cryptomining;

FIG. 4 illustrates a method of controlling power usage due to cryptomining in a data center, in accordance with various example embodiments; and

FIG. 5 illustrates a method for maintaining a relatively constant power usage for a data center, in accordance with various example embodiments.

### DETAILED DESCRIPTION

Reference will now be made to the exemplary embodiments illustrated in the drawings, and specific language will be used herein to describe the same. It will nevertheless be understood that no limitation of the scope of the disclosure is thereby intended. Alterations and further modifications of the inventive features illustrated herein, and additional applications of the principles of the disclosure as illustrated herein, which would occur to one skilled in the relevant art and having possession of this disclosure, are to be considered within the scope of the disclosure.

As discussed above, energy consumption for data centers is a very significant portion of the operating costs of the data center. Systems and methods that reduce the operating costs of the data center would be desirable. In particular, disclosed herein are new systems and methods for designing and operating a data center to lower operating costs (associated with power usage) of the data center. The systems and methods may be configured to facilitate reduction in operating costs by compliance with incentive programs provided by the utility electricity provider(s).

In accordance with various example embodiments, a data center is configured to perform cryptomining. In other example embodiments, the data center is configured to perform cryptomining and conventional computing. Cryptomining and conventional computing are similar in that both typically involve high-performance and high-power consumption. However, the usage patterns are typically different between conventional computing data centers and cryptomining data centers. For example, while cryptomining data centers tend to run 24/7 at constant power usage, conventional computing data centers will run at a power usage rate based on task demand, which fluctuates. Also, the computing patterns are different between them. While high performance computing with GPU or TPU in conventional computing data center is generally non-disruptive till task complete, cryptomining computing can be interrupted any time as needed.

One less desirable option for controlling crypto-miner power usage involves direct communication with the crypto miners. In a typical crypto-miner power usage management system, a crypto miner management system is configured to communicate via an application program interface with the crypto miners. In that embodiment, the crypto miner management system is configured to control each server in the data center, monitor the miners, and to selectively shut down (or not shut down) the miner. Although this system can control mining activity, and thus control the electrical power draw from the grid facilitating rapid reaction to a command to reduce power, it has drawbacks.

The first drawback is that it is an ‘open miner’ system (e.g., the crypto miner management system can tell the miner to start/stop mining) and because there is a communication link between the crypto miner management system and the miner, the ‘open miner’ system can be vulnerable/security risk.

The second drawback is that an upgrade to the crypto miner management system most likely would need to be made to both the miner and the crypto miner management system, at the same time. But coordinating simultaneous upgrades is a difficult process. Moreover, an update to the crypto miner would likely require stoppage of the mining activities for that miner.

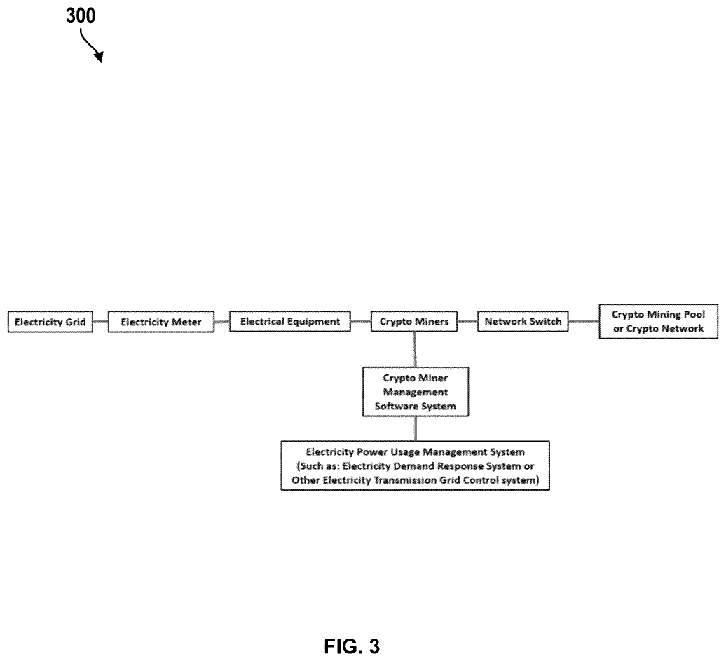

FIG. 3 illustrates this less desirable crypto miner power usage management system. The cryptomining data center installs a crypto miner management software system, which can access each miner's operation system. When the electricity power usage management system of a third party sends a power usage reduction or increase notification to the miner management software system, the miner management software system will reduce or increase miner power usage accordingly.

There are some serious intrinsic issues with the current miner power usage management system. The first is the security issue. The most important thing for crypto mining is a secure mining process. However, this power usage management system must enable crypto miner's operation system API (application programming interface) open to the third party's crypto miner management software system, which significantly exposes crypto miner to security attack.

The second is operation difficulty and reliability issue. To ensure that the crypto miner management software system can effectively manage each miner's operation, the software system needs to keep updated and be compatible with frequently updated miner firmware system. Any incompatible between the software system and each of thousands of miners will cause fault of miner power usage management and potential huge penalty due to failed commitment to power grid award programs.

### Active Crypto Mining Control

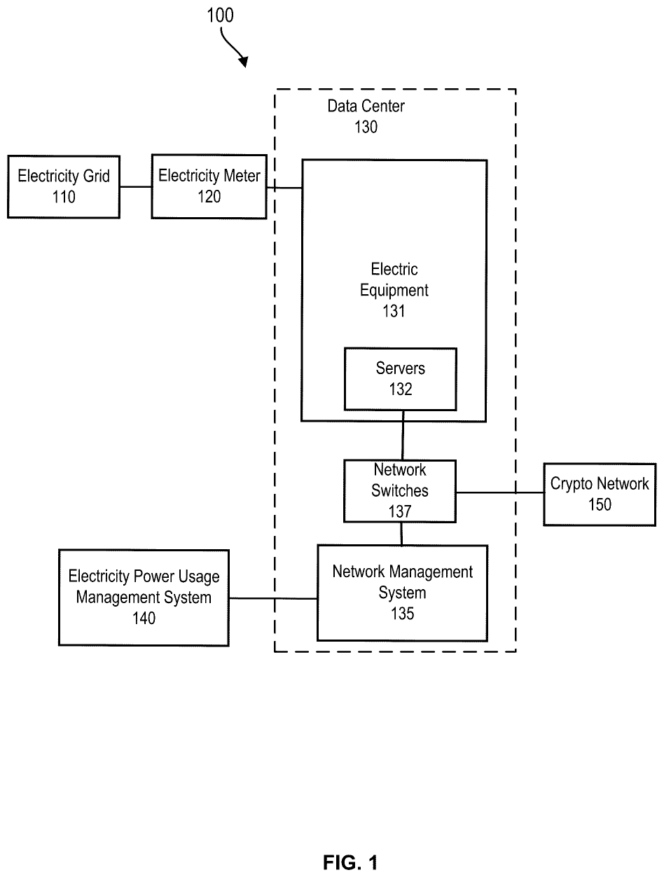

With reference now to FIG. 1, a system 100 is disclosed. In an example embodiment, the system 100 comprises an electricity grid 110, an electricity meter 120, a data center 130, and an electricity power usage management system 140. The data center 130 may further comprise electric equipment 131.

In an example embodiment, the electricity grid 110 comprises electricity generation devices such as, coal fired, oil fired, natural gas fired, nuclear powered, solar, wind or hydro generators, co-fired generators and/or the like. Moreover, the electricity grid 110 may receive power stored in batteries. Electricity grid 110 may comprise any suitable source of power, and is not limited in this regard. Electricity grid 110 may further comprise electric transmission lines and any suitable system for transmission of the power from the sources of such power to the data center. The electric generation and/or transmission may be provided by a utility, for example.

In an example embodiment, the electricity grid 110 is connected to an electricity meter 120 connected between the data center 130 and the electricity grid 110. Electricity meter 120 is configured to measure/record the amount of power provided from the electricity grid 110 to the data center 130. In some embodiments, e.g., where onsite power generation provides power back to the grid at some times, electricity meter 120 is configured to measure/record the power received at the data center 130 and provided by the data center, to facilitate net metering. The amount of power used by the data center may vary depending on computing demands in the data center, and other factors. The owners of the data center 130 will typically pay a power bill to a utility for the power used, in accordance with the measured/recorded power provided from the electricity grid 110 to the data center 130.

To ensure a proper operation, the electricity transmission grid system typical provide reward programs, such as demand-response program, coincidental peak power usage management system and others. The successful key to joining these programs and getting reward to reduce electricity price is to reduce power usage at the data center based on short notice.

In an example embodiment, data center 130 comprises electric equipment 131. The electric equipment 131 may receive power from the electricity grid 110 via the electricity meter 120. It is noted that the electric equipment 131 may also receive power from a second source. In one example embodiment, the electric equipment 131 receives power from a second electricity grid (not shown), providing a second path (and/or source of generation) for electricity to reach the data center in the event that a portion of the first electricity grid is unavailable (trips, brownout, etc). In this example, the second path may be tied to the same electricity meter 120, or may pass through a respective electricity meter (not shown). This disclosure is not limited in this regard. Moreover, the electric equipment 131 may receive power from a generator (e.g. diesel generator) or uninterrupted power source (e.g., battery or the like), which may be configured to provide power when the electricity grid is unavailable. This disclosure is not limited in this regard. These local sources of power from a generator or UPS would typically not pass through the electricity meter 120.

In an example embodiment, the electric equipment 131 may comprise electricity switchgear, UPS, transformers, mechanical cooling for both the environment and the servers, air filtration systems, batteries, capacitors, general lighting, distribution switchboards, the servers themselves and/or the like. In particular, the electric equipment 131 may comprise a plurality of servers 132. The amount of power provided to each of the plurality of servers 132 may depend on the processing occurring at each server. Secondarily, the amount of power consumed for cooling the servers and the environment around the servers may depend on the amount of processing occurring in the servers. Thus, the amount of power used by each server of the plurality of servers 132 may vary. Moreover, the power demand of each server of the plurality of servers 132 may depend directly on the computational tasks assigned to that server.

In accordance with various example embodiments, the servers may comprise Central Processing Units (CPUs), Graphics Processing Units (GPUs), Tensor Processing Units (TPUs), Application Specific Integrated Circuits (ASICs), and or the like, for different computing purposes. Moreover, any suitable servers may be used. The servers may be arranged in racks, though any suitable arrangement of servers may be used. In an example embodiment, the servers are configured to execute tasks, perform calculations, and or the like. In one example embodiment, for cryptomining, ASIC or GPU based miners are used to solve cryptographic puzzles. In another example embodiment, in an Artificial Intelligence (AI) data center, GPU/CPU servers are used to process model training, machine learning, and/or the like.

In an example embodiment, the system 100 may comprise a plurality of crypto miners (e.g., a plurality of servers similar to server 132) to perform calculations as requested by a crypto network 150. In an example embodiment, each server 132 comprises a crypto miner. For example, a crypto network 150 may issue a request that a crypto miner perform a calculation, the crypto miner may do the calculation (typically in competition with other crypto miners), and report back to the crypto network that it has done the calculation. The crypto network 150 can then determine who completed the task first, report that that task has been completed, pay the crypto miner, and start a new task.

The data center may comprise servers in racks and cabinets, routers, communication equipment, and switches, configured to send and receive data and instructions from outside of the data center 130 to the various servers. In particular, the data center may comprise network switches 137. Network switches 137 may be configured to interrupt the communication between the crypto network 150 and crypto miners (e.g. servers 132).

In an example embodiment, network switches 137 are arranged based on specific network topology design to achieve balanced and high-speed internet connectivity between crypto miner servers 132 and the crypto network 150. In one example embodiment, the network switches are arranged in layers, such as Layer 1, Layer 2, and Layer 3, though any suitable number of layers may be used. In one example embodiment, to ensure reliable internet connectivity for every crypto miner, Layer 1 network switches are used to control up to six crypto miners. However, the Layer 1 network switches may control any suitable number of crypto miners. In an example embodiment, the Layer 2 and Layer 3 networks switches are used to control all of the Layer 1 network switches. In an example embodiment, the network switch is a hardware switch. In one example embodiment, when a network topology has three layers of network switch, it may be called a 3 tier architecture, with Layer 1 configured to be an access layer, layer 2 configured to be a distribution layer, and layer 3 configured to be a core layer. Any suitable network switch may be used.

Thus, in an example embodiment, the network switches 137 are configured to stop mining activity by opening one of network switches 137 between the crypto network 150 and certain crypto miner servers 132. In one example embodiment, where a single Layer 1 network switch is connected between six servers 132 and crypto network 150, opening the networks switch 137 causes all six crypto miners to lose internet connection to crypto network 150 and stop working. Moreover, regardless of the number of servers 132 connected to one network switch 137, the system is configured to control the opening and closing of a link between those servers 132 connected to the network switch 137 and the crypto network 150. In an example embodiment, the system is configured to start/stop mining activity of specific miners or of a specific number of miners or of a subset of miners based on control of the network switch 137. In stating that the mining activity is stopped, this means that the tasks performed by the server associated with that mining activity are stopped. Thus, the power consumption of the server that was performing or that might have begun performing mining activity is greatly reduced. In this manner, system 100 is configured to stop mining activity relatively quickly. In an example embodiment, the crypto miner is configured to check internet connection regularly and when it finds no internet connection, it will stop running calculations, regardless of whether the task is done or not. In like manner, when appropriate, network switches 137 can be closed to connect selected crypto miner servers 132 to the crypto network 150 to rapidly start performing cryptomining activities on servers 132. Thus, the system 100 is configured to rapidly increase or reduce the number of crypto miner servers 132 that are performing mining activity in data center 130, causing the amount of power drawn by the servers 132 to change quickly. Stated another way, by controlling network switches 137, power usage of the data center 130 can be quickly reduced or increased.

In an example embodiment, system 100 comprises an electricity power usage management system 140 (EPUM system). The EPUM system 140 may be owned, for example by a third party who is the authorized and licensed representative or retailer of the electricity interconnection grid transmission system. In an example embodiment, the EPUM system may be a system developed by a third party that works with transmission system operators (TSOs), such as Independent System Operators (ISOs) and Regional Transmission Organization (RTOs), but is separate from the ISOs or RTOs.

In accordance with various example embodiments, the EPUM system 140 is configured to implement electricity demand response programs, coincidental peak power programs, etc. The EPUM system 140 may be configured to receive inputs such as market prices predicted demand, weather data, and or the like. The EPUM system 140 may be configured to determine pricing, to determine offers and/or rewards to perform grid services by commanding power usage at participating data centers, etc. The EPUM system, in an example embodiment, is configured to send a signal to a Network Management System 135 within data center 130. The signal may be a command signal, commanding the data center to reduce the power consumed by the data center to a pre-agreed electricity usage amount. In other example embodiments, the EPUM system 140 provides an indication of how much power should be reduced, e.g. 1 MW. For example, the EPUM system may send a command to the data center 130 to shut down 1 MW of power (an amount the data center has pre-agreed to shut down on command). Moreover, any signal from electricity power usage management system 140 may be used to cause data center 130 to rapidly change its power usage (increase/decrease), and/or to do so by a certain amount.

In an example embodiment, the system 100 further comprises a network management system 135. In an example embodiment, network management system 135 comprises a processor, a software management system and a User Interface App. In an example embodiment, the network management system 135 may be located in data center 130 (as illustrated in FIG. 1) or may be located remote to data center 130 (not shown). In an example embodiment, network management system 135 is configured to receive input from the electricity power usage management system 140 and to control network switches 137. For example, network management system 135 may receive data with a designed format through an Application Programming Interface (API). Upon receiving the data, the network management system 135 may be configured to process the data through an embedded program and send signals to selected network switches. In an example embodiment, the embedded program can be edited through the User Interface App. The embedded program may be configured to control the communication link between the crypto miners (server 132) and the crypto network 150. Any suitable format for the data may be used that facilitates communication between electricity power usage management system 140 and network management system 135. Thus, in an example embodiment, network management system 135 is configured to rapidly change power usage by commanding network switches 137 to open or close.

In an example embodiment, the network management system 135 is configured to receive the signal from electricity power usage management system 140, and to control various network switches based on the signal. For example, the network management system 135 may be configured to open one or more network switches of the plurality of network switches 137. In an example embodiment, the network management system 135 may be configured to interrupt or stop (or conversely to connect or start) communication of the crypto miner (e.g., servers 132 with the crypto network 150.

Network management system 135 may be configured to communicate with third party's electricity power usage management system. The network management system 135 may receive the command, calculate how many miners to shut down to achieve the commanded amount. For example, the network management system 135 may know that there are 6 miners per network switch. Though there could be any number of miners per networks switch, moreover there can be a different numbers of miners associated with one network switch than with another network switch. But the network management system 135 may further assess that each miner uses 0.3 kW or 9 kwhr. The network management system 135 can be configured to access and manage each smart network switch individually in the data center facility. Thus, the network management system 135 system may be configured to shut down (or turn on) X switches, in order to achieve a corresponding reduction (or increase) in power usage, or to attempt to get as close as possible to such.

The network management system 135 may be configured to control access by crypto miners to the crypto network, and accordingly to switchingly prevent or allow the crypto miners connected to that switch to work, and to do so in a relatively short time period (e.g, within 30 seconds).

In an example embodiment, system 100 controls crypto miner work on the servers and associated cryptomining power usage without the security risk of prior art crypto-miner power usage management systems. System 100, in an example embodiment controls crypto miner work on the servers of data center 130 without direct access to crypto miner server 132, nor to the crypto network. This is in contrast to systems that control crypto miners by interfacing directly with the crypto miner's operation system, and thus introduce a communication link that could possibly be exploited by nefarious entities.

In accordance with various example embodiments, the system 100 is configured to be updated without requiring any update at the crypto miner servers or crypto network. Moreover, the system 100 can be updated without interrupting on going crypto mining activity. This is because the only portions that might be updated are the network management system 135 and/or the electricity power usage management system 140, both of which are not in the stream of the crypto mining activity. Thus, an update to network management system 135 can occur while crypto mining activity is occurring. This is in contrast to systems that would interrupt crypto mining activity to update a control system that interfaces with the crypto miners as discussed above.

In accordance with other example embodiments, the system 100 is configured to achieve power usage reduction or increase with a very fast response time, such as, for example within 10 min after the signal from the electricity power usage management system 140 is received. Moreover, any suitable fast response time may be provided by system 100.

Thus, in accordance with various example embodiments, more secure, responsive and flexible power usage management systems are disclosed herein.

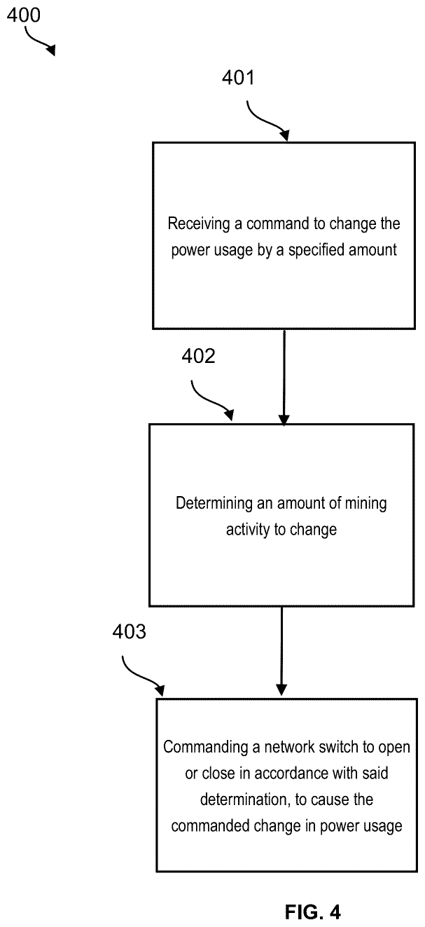

With reference now to FIG. 4, in accordance with an example embodiment, a method 400 for controlling power usage in a data center may comprise: receiving (401), at a network management system, a command to change the power usage by a specified amount. For example, the command may be a data signal indicating that 1 MW of power usage should be stopped. The method 400 may further comprise determining (402) an amount of mining activity to change. For example, the data center 130 may determine that 50 crypto miners should be stopped to achieve the desire power reduction. The method 400 may further comprise commanding (403) a network switch to open or close in accordance with said determination, to cause the commanded change in power usage. Because the network switch is located between the crypto miners and the crypto network, opening and closing the switch will cause the crypto mining activity to stop and start, respectively.

### Controlling For Nearly Constant Data Center Power Usage

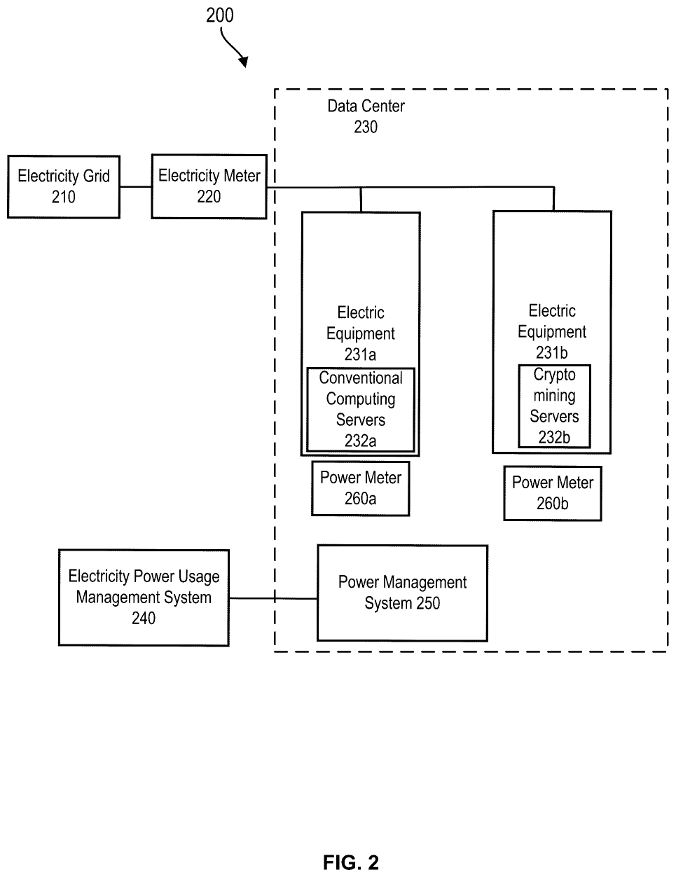

In accordance with another example embodiment, and with reference now to FIG. 2, a standard alone conventional computing data center will typically experience high peak power usage when running computing tasks, and low power usage when there are no tasks to complete. While there are seldom absolutely no tasks to complete in a conventional computing data center, it is common that the number of tasks vary and that the power usage in a dedicated conventional computing data center can fluctuate widely and irregularly. This usage pattern creates a relatively low loading factor power consumer and this is not preferred by the electricity grid. Therefore, it is common for utilities to charge higher electricity prices to data centers with widely varying loads. Thus, it is desirable to have new systems and methods for maintaining a more constant power usage for a data center. This result typically makes it possible to obtain lower priced electricity for the data center.

In addition, the total power consumption of a stand-alone conventional computing data center is usually not large enough to be serviced directly by a high voltage substation. Instead, a conventional computing data center is generally serviced by a “residential” or primary electrical account which are typically accompanied by a high electricity price. Thus, it is desirable to have new systems and methods for a data center to use a sufficiently high power usage to command commercial (lower) electricity pricing.

With reference now to FIG. 2, in an example embodiment, an innovative power management system 200 is disclosed. The power management system 200 comprises an electricity grid 210, similar to electricity grid 110 disclosed herein. The system 200 may further comprise an electricity meter 220, similar to electricity meter 120 disclosed herein. The system 200 may further comprise a data center 230. In accordance with various example embodiments, data center 230 may comprise first electrical equipment 231a and second electrical equipment 231b, similar to electric equipment 131. Both first electrical equipment 231a and second electrical equipment 231b may be in communication with and powered from electricity meter 220.

Electrical equipment 231a may further comprise conventional computing servers 232a and electrical equipment 231b may further comprise cryptomining servers 232b. For example, the servers 232a may comprise multi-core CPUs, high speed interconnects, and accelerators like Graphical Processing Units (GPUs) and/or Tensor Processing Units (TPUs). Moreover, the conventional computing servers may be any servers providing non-crypto mining data center tasks, or tasks with varying load needs. In an example embodiment, the cryptomining servers 232b may comprise Application Specific Integrated Circuits (ASICs) optimized for specific algorithms to solve different cryptographic puzzles.

In an example embodiment, the system 200 further comprises an electricity power usage management system 240, similar to the electricity power usage management system 140 disclosed herein. In an example embodiment, the system 240 is configured to provide a signal to cause the data center 230 to reduce or increase its power usage.

In accordance with various example embodiments, the system 200 further comprises a data center power management system 250. In an example embodiment, data center power management system 250 is located within data center 230 (as illustrated in FIG. 2) or may be located remote to data center 230 (not shown).

In an example embodiment, power management system 250 is configured to receive an input signal from the electricity power usage management system 240. The input signal may command that data center reduce or increase its power usage a specified amount, or the like.

In an example embodiment, power management system 250 is configured to receive input regarding the balance of power usage in the data center. In accordance with one example embodiment, power management system 250 receives input from a conventional computing power meter 260a and from a cryptomining power meter 260b. Conventional computing power meter 260a may comprise any sensor configured to measure the power used by the electrical equipment 231a, including the power used by the conventional computing servers 232a. Cryptomining power meter 260b may comprise any sensor configured to measure the power used by the electrical equipment 231b, including the power used by the cryptomining servers 232b. In this manner, power management system 250 is configured to determine the present power usage by both the conventional computing servers 232a and cryptomining servers 232b. However, in another example embodiment, power management system 250 may receive input from the electricity meter 220, and from one of conventional computing power meter 260a and cryptomining power meter 260b. In this embodiment, the power management system 250 can subtract the measured power (at power meter 260a or 260b) from the total power (at electricity meter 220) to determine the power used at the non-measured power meter. Moreover, any suitable method may be used to determine the power usage differential between the conventional computing servers 232a and the cryptomining servers 232b.

In an example embodiment, the power management system 250 is configured to determine a total power usage of the data center. This can be done directly from electricity meter 220, or from the total of the power meters 260a and 260b. In an example embodiment, power management system 250 is configured to compare a prior total power usage to the present total power usage, and to make adjustments (increase or decrease) the cryptomining power usage to maintain the total power usage nearly constant. It will be appreciated that the degree of control of power usage will be on the order of a single crypto miner's power usage, or a subset of crypto miners' power usage (e.g., the power usage of six crypto miners). Thus, nearly constant may be understood to be plus or minus the smallest controllable block of power controlled by a single switch. In an example embodiment, this may be 3 kWh to 18 kWh, or the like. In an example embodiment, the variation in power usage for the whole data center could be less than 3%, less than 2%, or less than 1%.

In various example embodiments, a database, memory or other suitable system may be used to store one or more prior total power usage measurements. The stored prior total power usage measurements may be recalled for comparison to present power measurements. Moreover, any suitable system for determining that the total power usage for the data center has changed (and how much change it has made) may be used. Moreover, the power management system 250 may be configured to make these adjustments without input from the electricity power usage management system 240. Moreover, the power management system 250 may be configured to anticipate change in power usage of conventional computing servers 232a and to command corresponding changes in power usage of crypto mining servers 232b to compensate for those anticipated changes in nearly real time. For example, a data center operator may provide power usage change information (anticipating future power usage based on customer orders and or the like) to the power management system 250, and power management system 250 may be configured to make adjustments to the total power usage in the crypto mining servers 323b.

In an example embodiment, power management system 250 is configured to make adjustments to the total power usage in the cryptomining power portion of the data center (the cryptomining servers 232b) through use of the system disclosed with reference to FIG. 1, for example. Moreover, any suitable system and method for controlling the total cryptomining power usage may be used.

With the generally true assumption, for the purposes of the contemplated data centers, that an unlimited amount of cryptomining is demanded, and thus, can be turned on and off at will, the system 200 is therefore configured to maintain a steady electrical load for the data center 230, even while the power load due to conventional computing servers varies widely. Again, this is accomplished by reducing ASIC crypto miner power usage when task driven GPU/TPU computing power usage increases and increasing ASIC crypto miner power usage when GPU/TPU computing power usage decreases. Furthermore, the combination of a computing center and cryptomining data center enables the new computing center to be serviced by a high voltage substation and reduce the electricity rate or cost.

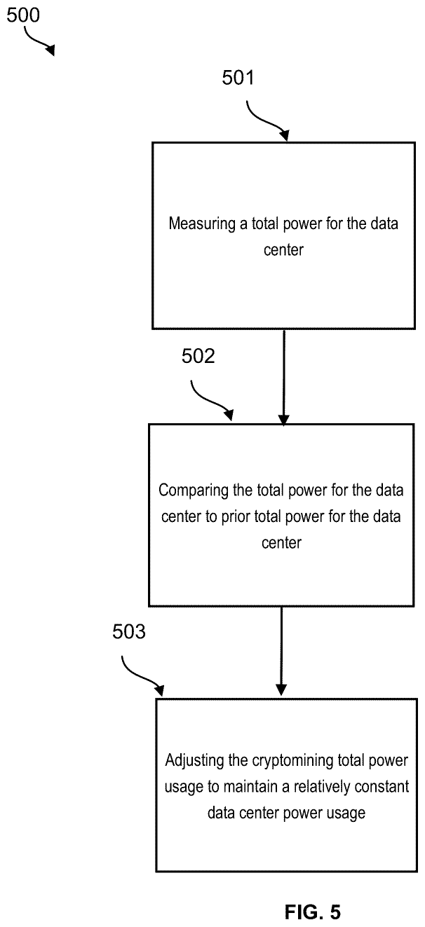

With reference now to FIG. 5, a method 500 is disclosed for maintaining a relatively constant total power for a data center. The method 500 may comprise, for example, measuring (501) a total power for the data center. The total power may be measured, for example, through use of one or more power meters. The method 500 may comprise, comparing (502) the total power for the data center to prior total power for the data center. The method 500 may comprise, adjusting (503) the cryptomining total power usage to maintain a relatively constant data center power usage.

In this manner, the system 100 and system 200 are configured to take proper advantage of reward programs offered by utility companies, such as demand-response, grid services, coincidental peak power usage management system and others. Cryptomining data centers can effectively reduce power usage by stopping miner computational process very quickly after receiving notification. The successful joining of these programs and getting rewarded to reduce the electricity prices can help to reduce electricity cost and operation cost of cryptomining data center.

Various components or modules disclosed herein, e.g., the electricity power usage management system 140/240, the network management system 135, and the power management system 250 may further comprise a graphical user interface (GUI) for displaying information to users and for receiving information from the users. Various components or modules disclosed herein, e.g., the electricity power usage management system 140/240, the network management system 135, and the power management system 250 may further comprise one or more controllers. In various embodiments, the controller may comprise a processor. In various embodiments, controller may be implemented as a single processor and associated memory. In various embodiments, the controller may be implemented as one or more processors and/or memories (e.g., a main processor and local processors for various components, a decentralized network of main processors, or the like). The controller can include a general-purpose processor, a digital signal processor (DSP), an application specific integrated circuit (ASIC), a field programable gate array (FPGA) or other programable logic device, discrete gate or transistor logic, discrete hardware components, or any combination thereof. The controller may comprise a processor configured to implement various logical operations in response to execution of instructions, for example, instructions stored on a non-transitory, tangible, computer-readable medium (e.g., memory) configured to communicate with the controller (e.g., charging instructions, charging sequences, or the like).

System program instructions and/or controller instructions may be loaded onto a non-transitory, tangible computer-readable medium having instructions stored thereon that, in response to execution by a controller, cause the controller to perform various operations. The term “non-transitory” is to be understood to remove only propagating transitory signals per se from the claim scope and does not relinquish rights to all standard computer-readable media that are not only propagating transitory signals per se.

In the present disclosure, the following terminology will be used: The singular forms “a,” “an,” and “the” include plural referents unless the context clearly dictates otherwise. Thus, for example, reference to an item includes reference to one or more items. The term “ones” refers to one, two, or more, and generally applies to the selection of some or all of a quantity. The term “plurality” refers to two or more of an item. The term “about” means quantities, dimensions, sizes, formulations, parameters, shapes, and other characteristics need not be exact, but may be approximated and/or larger or smaller, as desired, reflecting acceptable tolerances, conversion factors, rounding off, measurement error and the like and other factors known to those of skill in the art. The term “substantially” means that the recited characteristic, parameter, or value need not be achieved exactly, but that deviations or variations, including, for example, tolerances, measurement error, measurement accuracy limitations and other factors known to those of skill in the art, may occur in amounts that do not preclude the effect the characteristic was intended to provide. Numerical data may be expressed or presented herein in a range format. It is to be understood that such a range format is used merely for convenience and brevity and thus should be interpreted flexibly to include not only the numerical values explicitly recited as the limits of the range, but also interpreted to include all of the individual numerical values or sub-ranges encompassed within that range as if each numerical value and sub-range is explicitly recited. As an illustration, a numerical range of “about 1 to 5” should be interpreted to include not only the explicitly recited values of about 1 to about 5, but also include individual values and sub-ranges within the indicated range. Thus, included in the numerical range are individual values such as 2, 3 and 4 and sub-ranges such as 1-3, 2-4 and 3-5, etc. The same principle applies to ranges reciting only one numerical value (e.g., “greater than about 1”) and should apply regardless of the breadth of the range or the characteristics being described. A plurality of items may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary. Furthermore, where the terms “and” and “or” are used in conjunction with a list of items, they are to be interpreted broadly, in that any one or more of the listed items may be used alone or in combination with other listed items. The term “alternatively” refers to selection of one of two or more alternatives, and is not intended to limit the selection to only those listed alternatives or to only one of the listed alternatives at a time, unless the context clearly indicates otherwise.

It should be appreciated that the particular implementations shown and described herein are illustrative of the example embodiments and their best mode and are not intended to otherwise limit the scope of the present disclosure in any way. Furthermore, the connecting lines shown in the various figures contained herein are intended to represent exemplary functional relationships and/or physical couplings between the various elements. It should be noted that many alternative or additional functional relationships or physical connections may be present in a practical device.

As one skilled in the art will appreciate, the mechanism of the present disclosure may be suitably configured in any of several ways. It should be understood that the mechanism described herein with reference to the figures is but one exemplary embodiment of the disclosure and is not intended to limit the scope of the disclosure as described above.

It should be understood, however, that the detailed description and specific examples, while indicating exemplary embodiments of the present disclosure, are given for purposes of illustration only and not of limitation. Many changes and modifications within the scope of the instant disclosure may be made without departing from the spirit thereof, and the disclosure includes all such modifications. The corresponding structures, materials, acts, and equivalents of all elements in the claims below are intended to include any structure, material, or acts for performing the functions in combination with other claimed elements as specifically claimed. The scope of the disclosure should be determined by the appended claims and their legal equivalents, rather than by the examples given above. For example, the operations recited in any method claims may be executed in any order and are not limited to the order presented in the claims. Moreover, no element is essential to the practice of the disclosure unless specifically described herein as “critical” or “essential.”

1. A data center comprising:
electric equipment including a plurality of servers, comprising crypto miner servers;
a network switch between the crypto miner servers and a crypto network, for selectively interrupting communication between the crypto miner servers and the crypto network, and thereby controlling the use of one or more of the plurality of servers for crypto mining activity and thereby controlling the associated power usage of the data center; and
a network management system configured to receive communications from an electricity power usage management system and to control the network switch based on the communications to achieve a desired power usage for the data center.

2. The data center of claim 1, wherein the network management system is configured to be updated without stopping mining activity.

3. The data center of claim 1, wherein the network management system is configured to control mining activity without communicating directly with the crypto miner servers.

4. The data center of claim 1, wherein the communications received from the electricity power usage management system are indicative of how much increase or reduction of power usage by the data center is desired.

5. The data center of claim 4, wherein the network management system commands the network switch based on the communications received from the electricity power usage management system to achieve the desired increase or reduction of power usage by the data center.

6. The data center of claim 1, wherein the opening and closing of the network switch corresponds with stopping and starting, respectively, of associated crypto miner server processing and thus reduces and increases, respectively the power consumption of the data center.

7. A method for controlling power usage in a data center comprising crypto miner servers, the method comprising:
receiving, at a network management system, a command to change the power usage by a specified amount;
determining an amount of mining activity to change; and
commanding a network switch to open or close in accordance with said determination, to cause the commanded change in power usage, wherein the network switch is located between the crypto miner servers and a crypto network.

8. The method of claim 7, wherein determining the amount of mining activity to change comprises determining an amount of power per crypto miner server.

9. The method of claim 7, wherein the controlling of the communication between a crypto mining server and the crypto network can occur without directly communicating with the crypto miner servers or the crypto network.

10. The method of claim 7, wherein, the network management system can be updated without stopping any mining activity in the data center.

11. A data center comprising:
conventional computing servers having a total conventional computing server power usage;
crypto mining servers having a total crypto mining server power usage, wherein a total data center power usage equals the total conventional computing server power usage plus the total cryptomining server power usage; and
a power management system, wherein the power management system is configured to control the use of one or more the crypto mining servers to maintain a constant total data center power usage.

12. The data center of claim 11, wherein the power management system is configured to receive a signal from an electricity power usage management system and to control a network switch based on the communications, wherein the network switch is located between the crypto mining servers and a crypto network, wherein the network switch is configured to open or close to maintain the constant total data center power usage.

13. The data center of claim 11, wherein the power management system is configured to open/close switches to cause a corresponding decrease/increase in power usage in the crypto mining servers, causing the data center to maintain the constant total data center power usage.

14. The data center of claim 11, wherein the power management system receives measurement data associated with the total data center power usage and determines how much to adjust the power usage of the crypto mining servers to maintain a nearly constant total data center power usage, and commands network switches to open/close based on the determination, wherein the determination is based on at least one prior measurement of the total data center power usage.

15. A method comprising:
measuring, via one or more power meters, a total power usage for a data center;
comparing, via a processor at a power management system, the total power usage for the data center to a previously measured total power usage for the data center; and
adjusting a cryptomining total power usage to maintain a relatively constant data center power usage.

16. The method of claim 15, further comprising retrieving the previously measured total power usage from a memory.

17. The method of claim 15, further comprising determining an amount to adjust the cryptomining total power usage to maintain a relatively constant data center power usage, and further comprising commanding, by the power management system, network switches to open/close based on the determined amount of adjustment.
